(19) United States
(12) Patent Application Publication
(10) Pub. No.: US 2022/0351595 A1
(43) Pub. Date: Nov. 3, 2022

(54) COMBINATION RECESSED LIGHT AND SMOKE SENSOR AND CARBON MONOXIDE SENSOR SYSTEM

(71) Applicants: Brian A Ryznic, Defuniak Springs, FL (US); john E Ryznic, Fellsmere, FL (US)

(72) Inventors: Brian A Ryznic, Defuniak Springs, FL (US); john E Ryznic, Fellsmere, FL (US)

(21) Appl. No.: 17/866,486

(22) Filed: Jul. 16, 2022

Related U.S. Application Data
(63) Continuation-in-part of application No. 17/354,661, filed on Jun. 22, 2021.
(60) Provisional application No. 63/225,196, filed on Jul. 23, 2021.
(60) Provisional application No. 63/241,036, filed on Sep. 6, 2021.
(60) Provisional application No. 63/014,262, filed on Apr. 23, 2020.

(51) Int. Cl. G08B 17/10; G08B 21/14

(52) U.S. Cl. CPC G08B 17/10; G08B 21/14

(57) ABSTRACT

A combination recessed light with a smoke sensor and a carbon monoxide detector to detect for both smoke and carbon monoxide gas in a room. The recessed light can be a wafer style recessed light with an LED light source with a cover plate forming a smoke collection chamber with a smoke detecting sensor located within. A smoke collecting area is located below the LED light source and is connected to the smoke collection chamber thru one or more holes. A box mounted to a wall of the room can have a carbon monoxide sensor, a battery, and speaker, and a test button to sound an alarm for both the smoke sensor and the carbon monoxide sensor. The test button is used to test both the smoke detector and the CO sensor. An array of recessed lights is mounted to a ceiling and a power convertor device converts 110-volt power to 20-volt power that is supplied to each of then LED light sources.

### CROSS-REFERENCE TO RELATED APPLICATIONS

The present application is a CONTINUATION-IN-PART of U.S. Regular application Ser. No. 17/354,661 filed Jun. 22, 2021 and entitled COMBINATION RECESSED LIGHT AND SMOKE DETECTOR, which claims the benefit to U.S. Provisional Application No. 63/014,262 filed on Apr. 23, 2020 and entitled RECESSED LIGHT WITH INTEGRAL SMOKE DETECTOR; and the present application also claims the benefit to U.S. Provisional Application No. 63/225,196 filed on Jul. 23, 2021 and entitled COMBINATION RECESSED LIGHTING AND SMOKE DETECTOR AND CARBON MONOXIDE SENSOR; and the present application also claims the benefit to U.S. Provisional Application No. 63/241,036 filed on Sep. 6, 2021 and entitled RECESSED LIGHT AND SMOKE DETECTOR SYSTEM FOR MULTIPLE ROOMS.

### TECHNICAL FIELD

The disclosure generally relates to a recessed light with a smoke detector, and more specifically to a recessed light and smoke sensor and carbon monoxide sensor system.

### BACKGROUND

A recessed light fixture is a source of light mounted in a ceiling in which a light surface is flush with a ceiling surface to appear as one smooth surface. A recessed light can be a can light or a wafer light. A wafer recessed light is a thin recessed light with an LED light source. A can light uses a light bulb in a socket within a bell-shaped can that extends up and in to a space above the ceiling surface. A recessed light can be circular or rectangular is shape as it appears in the ceiling surface. A wafer recessed light is typically an LED light source in order to form a thin light fixture to fit within a small space above the ceiling.

A smoke detector can be installed in a room of a dwelling or a business in which people sleep or work to be awaken or alerted to a detection of smoke in a room indicating a fire. A smoke detector can have a mounting surface that is secured to a ceiling surface and the detector body extends out from the mounting surface such that the smoke detector sticks out from the flat ceiling surface. FIG. 1 shows a room with an array of recessed lights 104 on a ceiling 102 and a smoke detector 106 extending from the ceiling toward the room. The smoke detector 106 is a separate device from the recessed lights 104. A smoke detector can include a battery to provide power in the case when power to the building is lost, a speaker to sound an alarm, and a test button or switch that is used to test if the smoke detector is working. To test the smoke detector, one must use a ladder to reach the height of the test button on the smoke detector in order to push the test button.

A carbon monoxide (CO) sensor can also be installed in each room of a dwelling or business in which are occupied by a person. In prior art designs, a smoke detector was formed integral with a carbon monoxide sensor and both mounted on the ceiling of a room. This design was not workable since smoke rises to the ceiling while carbon monoxide sinks to the floor. Smoke is heavier than air while carbon monoxide is lighter than air.

There is a need in the art for a system and a method that addresses the shortcomings discussed above.

### SUMMARY

In one aspect, an arrangement of wafer style recessed lights each having an LED light source is mounted in a ceiling with one of the wafer lights having a smoke detecting sensor hidden from view from the room. A box mounted on a wall in the room includes a carbon monoxide (CO) sensor and a battery, a speaker, and test button to test both the smoke sensor and the CO sensor.

In another aspect, a wafer style recessed light with an LED light source includes a cover plate mounted over the wafer light to form a smoke chamber in which a smoke detection sensor is located. One or more holes connect the smoke chamber to a location below the wafer light to channel smoke from the room into the chamber where the smoke detection sensor is located.

In another aspect, a wafer style recessed light with a LED light source includes a smoke chamber cover plate located on one side of the wafer light so that the recessed light with the smoke detection sensor can fit underneath a rafter supporting the ceiling. The wafer light with the smoke detection sensor and chamber can be rotated within an opening of the ceiling to mounting of the wafer light under the rafter.

In another aspect, a wafer style recessed light with an LED light source includes a horizontal flange to mount the wafer light in an opening of the ceiling, and a smoke collection area below the light source for smoke to collect. One or more holes connect the smoke collection area to a smoke collection chamber formed above the wafer light by a cover plate in which a smoke detection sensor is located.

In another aspect, a wafer light style recessed light with an LED light source includes a horizontal flange to mount the wafer light in an opening of the ceiling, and a smoke collection area below the light source for smoke to collect. One or more steps are formed between the horizontal flange and a smoke collecting area located below the LED light source. One or more holes located above the step or steps and connect the smoke collection area to a smoke collection chamber formed above the wafer light by a cover plate in which a smoke detection sensor is located.

Other systems, methods, features, and advantages of the disclosure will be, or will becomes, apparent to one of ordinary skill in the art upon examination of the following figures and detailed description. It is intended that all such additional systems, methods, features, and advantages be included within the description and this summary, be within the scope of the disclosure, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a schematic view of a room with a ceiling having an array of recessed lights mounted flush to the ceiling surface and a separate smoke detector, according to an embodiment;

FIG. 2 is a schematic view of a room with a ceiling having an array of recessed lights with one of the recessed lights also having a smoke detector, according to an embodiment;

FIG. 3 is a cross section view of a recessed light with a smoke detector from a side view, according to an embodiment;

FIG. 4 is a cross section view of a recessed light with a smoke detector from a top view, according to an embodiment;

FIG. 5 is a cross sectional schematic view of a rectangular shaped smoke collecting area with a vertical smoke hole, according to an embodiment;

FIG. 6 is a cross sectional schematic view of a curved shaped smoke collecting area with a vertical smoke hole;

FIG. 7 is a cross section view of a recessed light with a smoke detector sensor, according to an embodiment;

FIG. 8 is a front view of a wall mounted box having a carbon monoxide sensor and a speaker, according to an embodiment;

FIG. 9 is a front view of the box of FIG. 8 with the carbon monoxide sensor and the speaker, and with a door opened to show a test button and a battery, according to an embodiment;

FIG. 10 is a cross section view of a recessed light with a smoke detector with a smoke cover plate offset from a ceiling truss, according to an embodiment;

FIG. 11 is a cross section view of a recessed light with a smoke detector with an angled hole to channel smoke to a chamber, according to an embodiment;

FIG. 12 is a cross section view of a recessed light with a smoke detector with an angled hole to channel smoke to a chamber and a stepped surface, according to an embodiment;

FIG. 13 is a cross section view of a recessed light with a smoke detector with an angled hole to channel smoke to a chamber formed on a side of the recessed light assembly, according to an embodiment;

FIG. 14 is a schematic view of an arrangement of recessed lights in a ceiling in which one power converter is used for all of the multiple recessed lights.

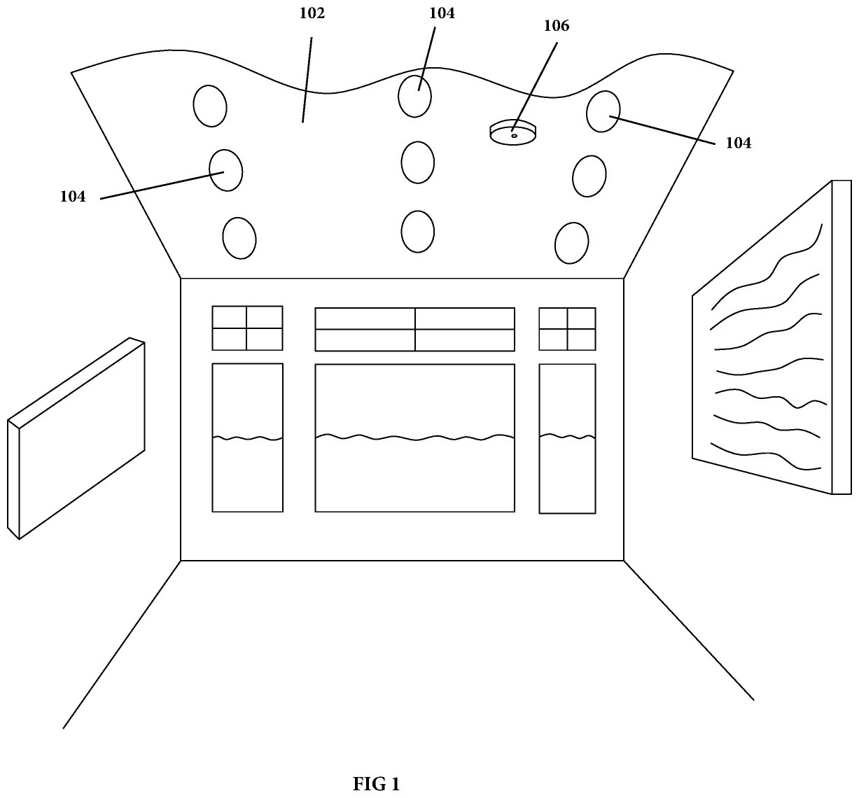

### DETAILED DESCRIPTION

The embodiments provide a room in a dwelling or a building with a recessed light with an integral smoke detector connected to a wall mounted box that includes a carbon monoxide sensor along with a backup battery and a speaker and a test button in which both the smoke detector in the ceiling and the carbon monoxide sensor on the wall can be tested for operation and for ease of changing the battery. Different embodiments of a recessed light of the wafer light type are shown with a smoke detector sensor. A smoke detector can include a smoke sensor to detect a presence of smoke. A smoke detector can include other electronics to alert or indicate that the sensor has detected smoke.

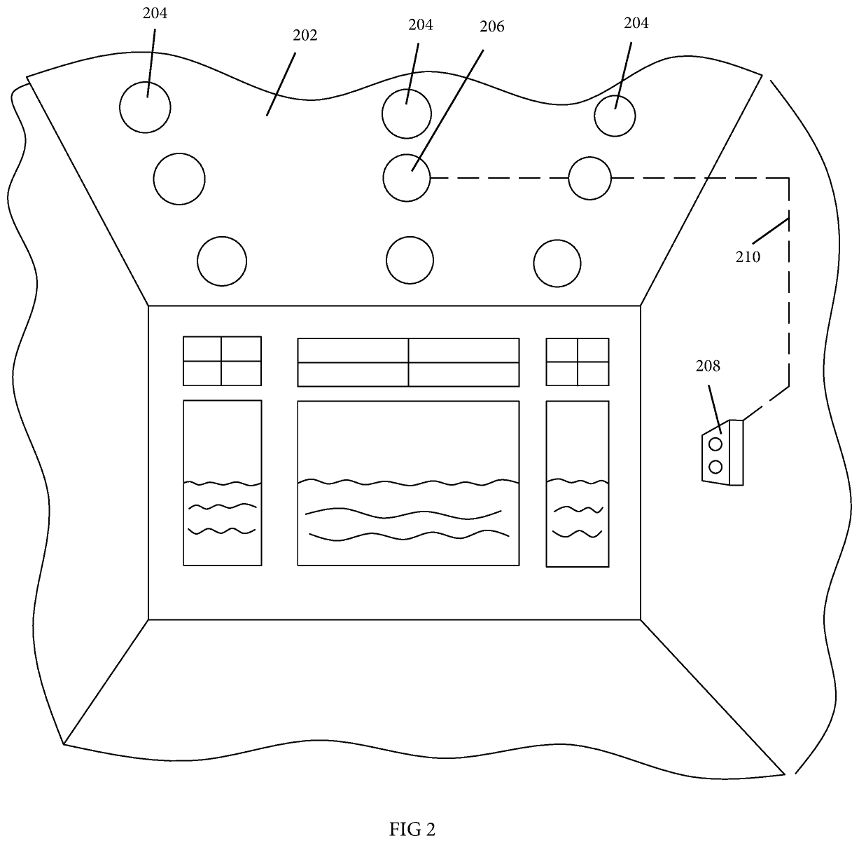

In one aspect, FIG. 2 shows a room with a ceiling 202 in which an array of recessed lights 204 are arranged. In one embodiment, a rectangular array of recessed lights can be used with two rows of recessed lights forming a rectangular array. One of the recessed lights 206 in the array can include a smoke detector. Each of the recessed lights can be circular shaped or rectangular shaped from a front view. Each recessed light is connected to the power grid of the house to power both the light source and the smoke detector. The smoke detector can include a backup battery to supply power to the smoke detector if the power grid of the house goes out. A wafer style recessed light can use an LED light as the light source since an LED light can be a very thin strip of LED lights to form a thin wafer light that can fit in a thin space within a hole cut out in a ceiling surface.

In one aspect, a wall mounted smoke detector testing device 208 is connected to a recessed light having a smoke detector 206 with a wire 210 hidden from view. The wall mounted smoke detector testing device 208 can include a switch or a push button that can be used to test the smoke detector 206. The smoke detector is hardwired to the electrical grid of the house and thus power both the light source and the smoke detector. The LED light of the recessed light is connected separately to the electrical grid of the house so that the lights can be turned on and off while the smoke detector is always connected to electrical power. The smoke detector can include a backup battery for a situation when the electrical power for the house goes out, the backup battery will allow the smoke detector to function. When the switch or push button is activated and the smoke detector is working properly, a speaker associated with the smoke detector will make a sound indicating that the smoke detector is working properly. For a tall ceiling with the recessed light and smoke detector 206, a person would need a ladder to reach a test button or switch on a smoke detector. Since the smoke detector is hidden from view by the recessed light, the recessed light and smoke detector would have to be removed from the ceiling to test the smoke detector. In one embodiment, the test switch or button is mounted to the wall in the room so a person can test the smoke detector without having to reach for the ceiling mounted smoke detector. In one embodiment, the smoke detector is hidden from view and a wall mounted device 208 for testing the smoke detector can allow for a person to test the smoke detector without having to remove the recessed light 206 from the ceiling 202.

In one aspect, the wall mounted device 208 can be connected to the smoke detector with a wire hidden from view.

In another aspect, smoke detector testing device 208 can be connected to the smoke detector 206 for testing using a wireless connection. A wireless device like a TV remote control can be used to supply a signal to the smoke detector for testing. If the smoke detector goes off due to smoke appearing, the wireless smoke detector testing device can also be used to turn off the alarm of the smoke detector. If several rooms each having a recessed light with a smoke detector is used, one smoke detector testing device can be used for test or turn off all of the smoke detectors.

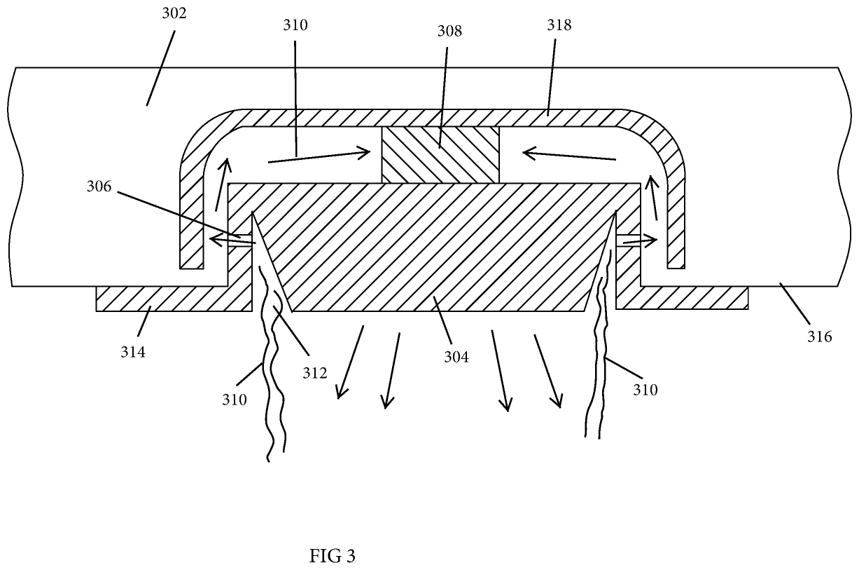

FIG. 3 shows an embodiment of a wafer style recessed light with a smoke detector from a cross sectional side view. The recessed light 304 includes a source of light that can be an LED light. an LED light source can be used in a wafer light due to the recessed light being very thin compared to a can light. The recessed light can include a mounting extension 314 that can be used to mount the recessed light flush with a ceiling surface 316 of a ceiling 302 in a room. The mounting extension 314 can include a vertical extending section and a horizontally extending section. The mounting extension 314 can form a surface to the recessed light 304 and smoke detector flush with the ceiling surface 316. An annular shaped smoke collecting opening or chamber 312 can be formed between the light source 304 and the mounting extension 314 in which smoke can collect and then pass through several holes 306 formed in the vertical portion of the mounting extension 314 and flow to the smoke detector 308. In one embodiment, a smoke guiding plate 318 can be mounted over the wafer light 304 to direct the smoke from the holes 306 into the smoke detector sensor 308. In one embodiment, the annular opening 312 can be V-shaped. In another embodiment, the annular opening 312 can be U-shaped. In one embodiment, the smoke detector 308 is located above the recessed light 304. The annular smoke collecting chamber 312 can allow for the smoke to accumulate before passing through one or more holes 306 in the mounting extension 314 on the way to the smoke detector 308. The smoke guide plate 318 can be a separate part that can be secured over the wafer light assembly to form a smoke collection chamber in which the smoke detection sensor 308 is located.

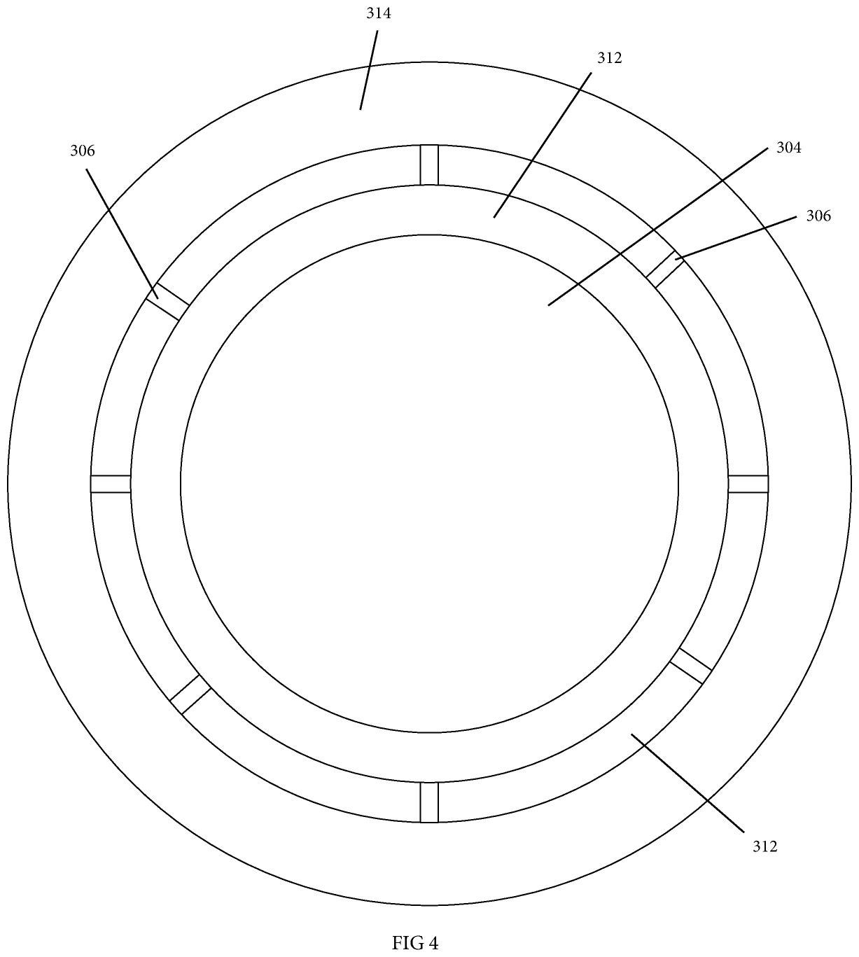

FIG. 4 shows a cross sectional side view of the recessed light and smoke detector. The light source 304 is inside of the annular smoke collecting chamber 312 which can be inside of the mounting extension 314 having the holes 306. The annular smoke collecting chamber 312 allows for smoke to accumulate before passing through the holes 306 and then to the smoke detector 308.

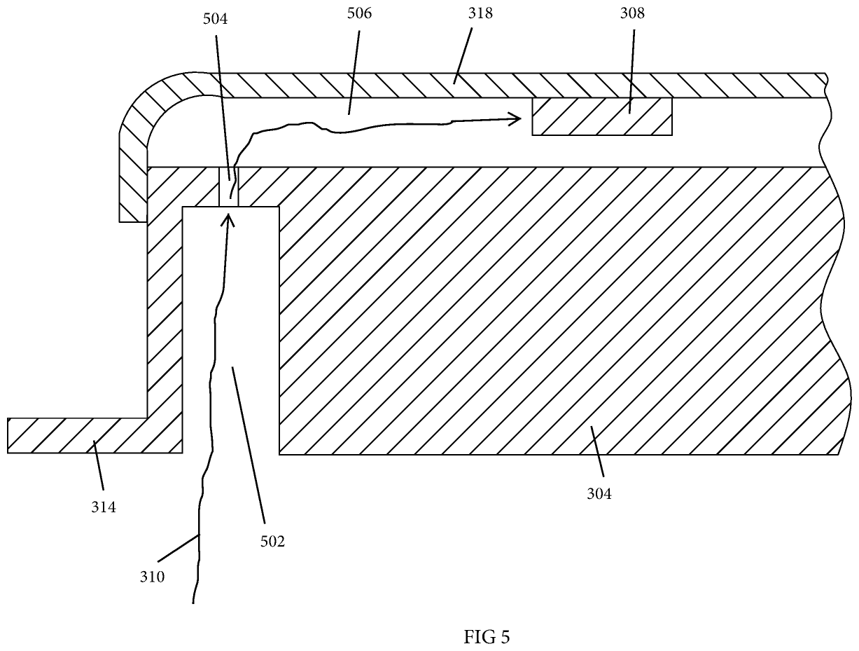

In one embodiment, a smoke collecting chamber 312 can be rectangular in cross sectional shape like in FIG. 5. The smoke hole 504 can be extending vertically into a smoke guiding channel 506 formed by the smoke guiding plate 318. Smoke 310 from the room will flow up and into the smoke collecting chamber 502 and thru the smoke hole 504 and into the smoke guiding channel 506 to the smoke sensor in the smoke detector 308.

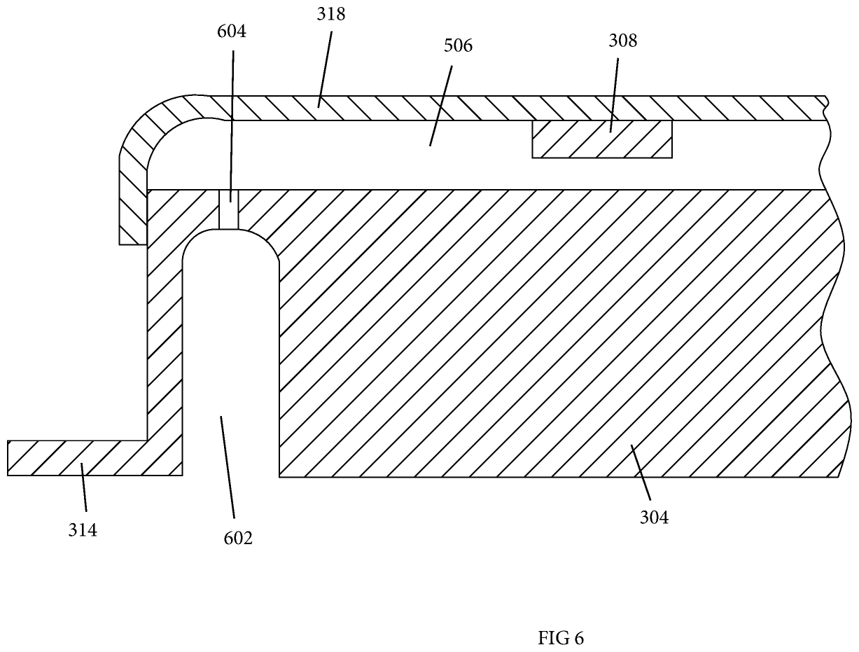

In another embodiment, a smoke collecting chamber 602 in FIG. 6 can be rounded on the top with a smoke hole 604 extending from the smoke collecting chamber 602 to the smoke guiding channel 506 under the smoke guiding plate 318 toward the smoke sensor in the smoke detector 308.

In one embodiment, the smoke collecting chamber can be a full annular collecting chamber extending around the outside of the light source of the recessed light. In another embodiment, the smoke collecting chamber can be an opening that does not extend in a full annular way but at a small arc around the light source. In another embodiment with a rectangular shaped light source, the smoke collecting chamber can extend along all four sides of the rectangular shaped light source. In another embodiment, one or more small openings can be the smoke collecting chamber or areas that do not extend along all four sides of the rectangular shaped light source.

The recessed light with the smoke detector can provide for an appealing look for a ceiling with several recessed lights in which one of the recessed lights includes a smoke detector that is hidden from view while looking the same as the recessed lights that do not include a smoke detector. Since all the recessed lights can be illuminated, the appearance can be appealing to a person in the room.

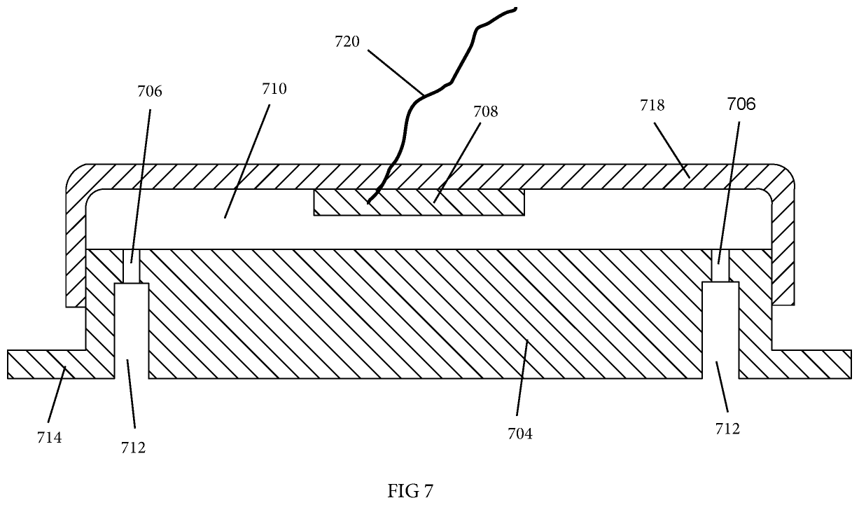

FIG. 7 shows another embodiment of a wafer style recessed light with a smoke detector sensor. The recessed light includes a LED light 704 mounted in a frame that can have a flange 714 to mount around an opening in a ceiling. The recessed light assembly can have a smoke accumulating opening 712 with a hole 706. The opening 712 can be an annular opening formed outside of the LED light 704. One or more holes 706 can channel smoke into a channel 710 formed by a disk or cover plate 718 that can be attached to the light fixture assembly. The disk or cover platen 718 can form a smoke channel 710 to direct smoke from the smoke hole 706 to the smoke sensor 708. A vent hole can be used to channel smoke from the chamber 710 out from the chamber 710 to form a flow path for smoke. A smoke detector sensor 708 can be mounted to the disk 718 inside of the channel 710 where smoke can pass from the hole 706. A wire 720 can connect the smoke detector sensor 708 to an electronic device with a speaker and a test button to sound an alarm when the detector 708 detects smoke.

FIG. 8 shows a box 802 that can be mounted to a wall in a room in which the recessed light with a smoke detector can be installed in the ceiling of the room. The box 802 can include a carbon monoxide sensor 808 to detect carbon monoxide within the room. The box can include a speaker 816 that can make a sound of an alarm when the smoke detector detects smoke in the room or the carbon monoxide sensor detects carbon monoxide in the room. Two box cover mounting screws 804 and 806 can be used to secure a cover plate to then box 802.

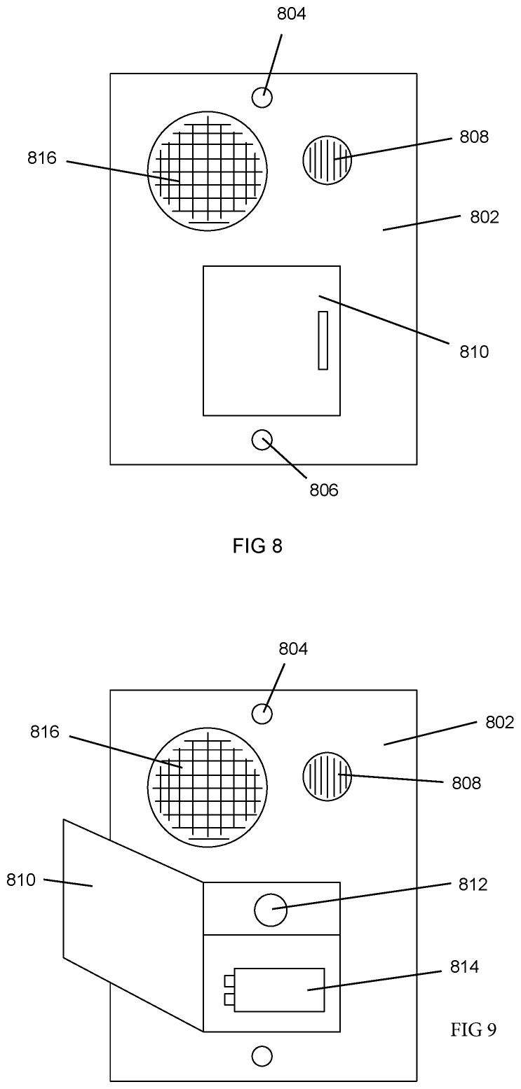

FIG. 9 shows the box 802 mounted to the wall with a door 810 opened. Inside the door is a test button 812 and a battery 814. The test button 812 can be pushed to test the smoke detector or the carbon monoxide sensor. If both sensors are working, the speaker will sound an alarm when the test button is pushed. In an embodiment, the box can include a first test button for the smoke detector and a second test button for the carbon monoxide sensor to test the two sensors separately. The battery can be a 9-volt battery.

The recessed light with the smoke detector sensor can be mounted in a ceiling of a room and connected by a wire to the box 802 mounted to a wall of the same room. The circuitry for the smoke detector can be within the box 802 and the smoke detector sensor mounted to the recessed light assembly can be connected by a wire to the box to make a smoke detector device. The box can also include the carbon monoxide sensor 808. The battery 814 can provide backup electrical power for the smoke detector and the carbon monoxide sensor 808 if the main power to the dwelling is cur off. The box can include a test button for both the smoke detector and the carbon monoxide sensor so that a person can test both sensors by pushing the test button. A person can test the smoke detector without having to use a ladder to reach the recessed light fixture. If either of the smoke detector sensor or the carbon monoxide sensor detects smoke or CO, then the speaker will sound an alarm.

In another embodiment, the box can have a different sounding alarm for the smoke detector and the carbon monoxide sensor. a first sound can occur when the smoke sensor detects smoke in the room and a second sound can occur when the CO sensor detects carbon monoxide in the room. Thus, a person can then be alerted as to which sensor is sounding the alarm.

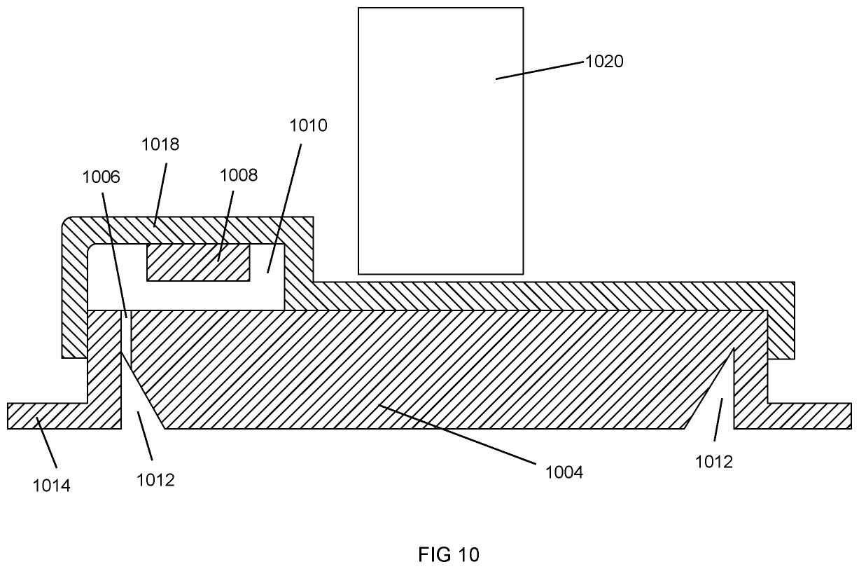

FIG. 10 shows an embodiment with a recessed light and a smoke detector that can fit under a truss of the ceiling. The recessed light assembly can have an LED light 1004, a flange 1014, a smoke collection chamber 1012, a cover plate 1018, a smoke detector sensor 1008, and a hole 1006 connecting the smoke collection chamber 1012 to the space 1010 formed between the cover plate 1018 and the recessed light assembly. The space 1010 is formed to a side of the wafer recessed light so that the assembly can fit under a truss 1020 that forms part of the ceiling support. The wafer light and smoke detector assembly can be rotated within an opening in the ceiling so that the cover plate 1018 is not under the ceiling truss 1020. Smoke in a room rises and collects in the chamber 1012, then passes thru one or more holes 1006 into the space 1010 where the smoke detector sensor 1008 is located under the cover plate 1018.

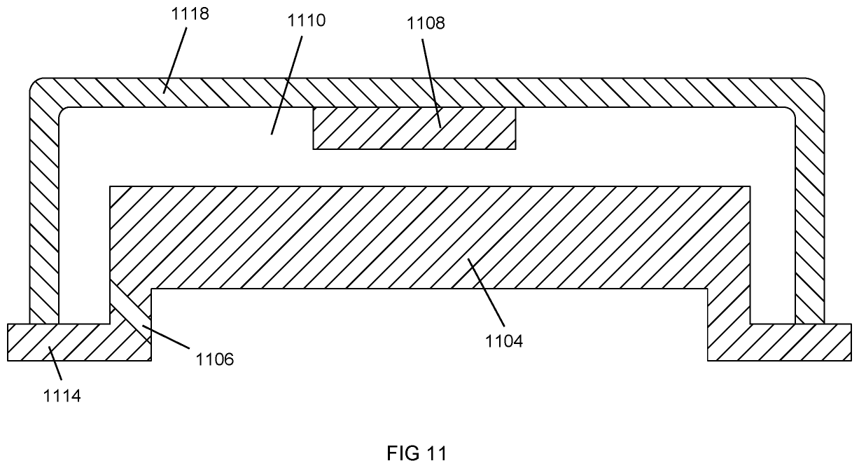

FIG. 11 shows an embodiment of a recessed light with a smoke detector sensor with a LED light 1104, a flange 1114, a cover plate 1118, and a smoke detector sensor 1108. One or more angled holes 1106 connect the underside of the recessed light assembly to the space or channel 1110 under the cover plate 1118 where the smoke detector sensor 1108 is located. In the FIG. 11 embodiment, the LED light is recessed into the flange 1114 and not flush with the bottom surface of the flange 1114. This creates a smoke collection chamber underneath the LED light 1104 in which smoke can collect and then pass thru the one or more holes 1106 and into the space 1110 where the smoke detector sensor 1108 is located. In another embodiment, the holes 1106 can be horizontal instead of angled.

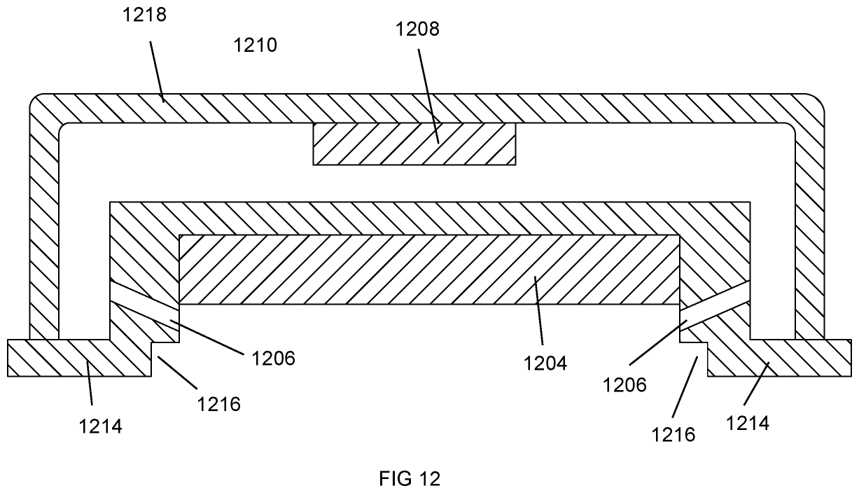

FIG. 12 shows an embodiment of a recessed light with a smoke detector sensor in which the flange 1214 can include one or more steps 1216 with the LED light 1204 mounted within and above the step or steps. The space below the LED LIGHT 1204 and inside of the step 1216 or steps can form a smoke collection area below the wafer recessed light and be connected by one ore more smoke holes 1206 to a smoke chamber formed by the cover plate 1218. Smoke passing thru the hole or holes 1206 is directed by the plate 1218 to the smoke detection sensor 1208. The smoke hole 1206 can be angled from the horizontal or parallel to the horizontal. The smoke holes 1206 can also be formed in the flange part 1214 of the wafer recessed light but would be visible to a person standing below the wafer recessed light having the smoke detector.

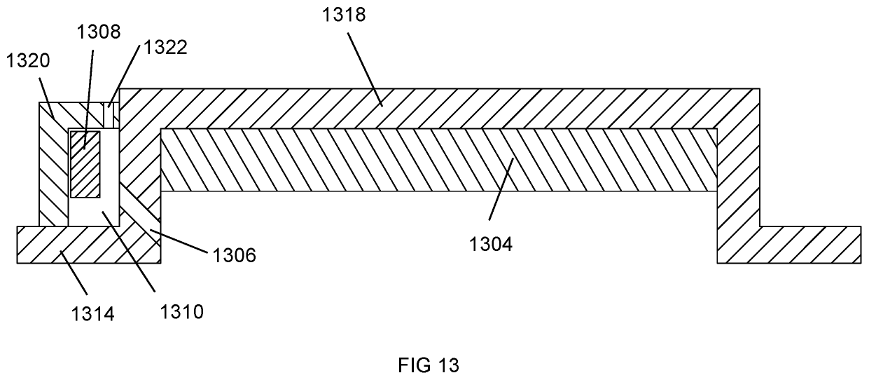

FIG. 13 shows an embodiment of a recessed light with a smoke detector sensor in which a smoke accumulation chamber is formed on a side of the wafer recessed light 1318. A cover plate 1320 that extends around d the wafer light 1318 at less than 360 degrees forms a smoke collection chamber 1310 in which a smoke detection sensor 1308 is located. A smoke inlet hole 1306 connects the lower side of the wafer light 1304 to the smoke chamber 1310. An exit hole 1322 allows for the smoke to flow out from the smoke collection chamber 1310. One or more smoke holes 1306 can be used.

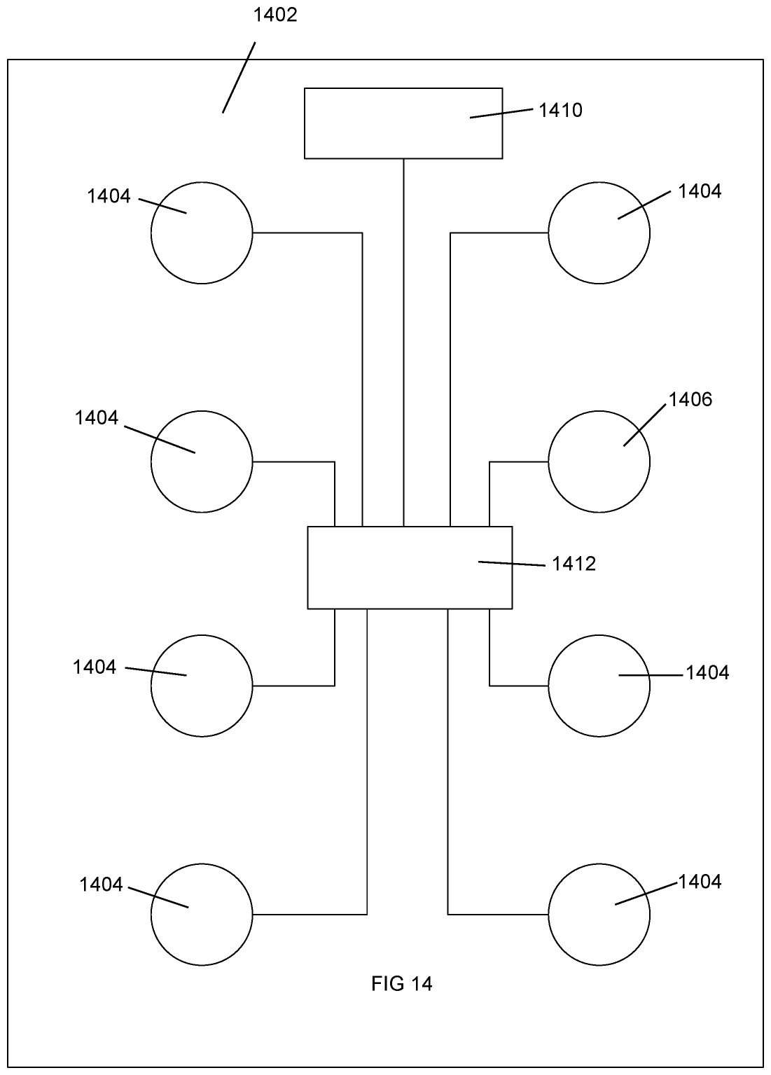

FIG. 14 shows an embodiment in which a room can have several recessed lights each having an LED light source supplied by a common 110-volt source 1410 and with a common power reducer 1412 that steps down the voltage from 110 to 20 volts. In one embodiment, an array of eight wafer recessed lights with LED light sources 1404 are arranged in a ceiling of a room. One of the wafer lights 1406 can have a smoke detector associated with the wafer LED light. each of the wafer lights is supplied with 20 volts from the common power reducer 1412. In this embodiment, a power reducer from 110 volts to 20 volts in not required for each LED light source.

A system with a recessed light with a hidden smoke detector can be used in a dwelling or a business having multiple rooms in which each room can have a smoke detector. Each of the smoke detectors can be connected in a hard wire way or a wireless way or in a combination of hard wire and wireless connections. In this system, if one smoke detector senses smoke, all of the smoke detectors will sound an alarm in each of the rooms. Each smoke detector in each room can also be connected to a control box with a speaker and a test button and a carbon monoxide sensor to detect for smoke and carbon monoxide. If either smoke or carbon monoxide is detected in one room, then all of the rooms will sound off an alarm.

With the system above, a dwelling or a business already having a smoke detector system connected using a hard wire system can have an additional smoke detector or carbon monoxide sensor added using a wireless connection. One of the hard-wired smoke detectors can be replaced with a new smoke detector that can communicate in a wireless way to the added smoke and/or carbon monoxide sensor. Or, if a dwelling or a building does not have any hard-wired smoke detectors, a system using multiple wireless connected smoke detectors can be installed in multiple rooms without having to run hard wires in the walls.

While various embodiments of the invention have been described, the description is intended to be exemplary, rather than limiting, and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the attached claims.

1. A combination recessed light and a smoke detector and a carbon monoxide sensor comprising:
a recessed light with an LED light source mounted in a ceiling of a room;
a smoke detector sensor associated with the wafer recessed light;
a box mounted to a wall of the room; and,
the box having a test button and a battery and a speaker and a carbon monoxide sensor; wherein the speaker will sound an alarm when the smoke sensor or the carbon monoxide sensor detects smoke or carbon monoxide in the room, and the speaker will sound an alarm when the test button is depressed.

2. The combination recessed light and smoke detector and carbon monoxide sensor of claim 1, and further comprising:
the recessed light is a wafer recessed light;
the wafer recessed light includes a cover plate forming a smoke chamber with a smoke detection sensor; and,
a smoke hole connecting a lower aside of the recessed light to the smoke chamber.

3. The combination recessed light and smoke detector and carbon monoxide sensor of claim 1, and further comprising:
the box includes a second test button for the carbon monoxide sensor.

4. The combination recessed light and smoke detector and carbon monoxide sensor of claim 1, and further comprising:
the speaker produces an alarm sound for the smoke detector different in sound from the carbon monoxide sensor.

5. The combination recessed light and smoke detector and carbon monoxide sensor of claim 1, and further comprising:
the recessed light is a wafer light with an LED light source;
a cover plate over the wafer light;
the cover plate forming a smoke chamber off to one side of the wafer light so as not to interfere with a ceiling rafter;
a smoke detection sensor mounted within the smoke chamber; and,
a smoke hole in the wafer light to direct smoke from below the wafer light to the smoke chamber; wherein,
the wafer light with the smoke chamber can ben rotated within an opening of a ceiling to fit under a rafter above the ceiling.

6. The combination recessed light and smoke detector and carbon monoxide sensor of claim 1, and further comprising:
the recessed light is a wafer light with an LED light source;
a cover plate over the wafer light;
a first smoke accumulation chamber formed by the cover plate and the wafer light;
a smoke detection sensor located within the smoke accumulation chamber;
a second smoke accumulation chamber formed below the LED; and,
a smoke hole connecting the second smoke accumulation chamber to the first smoke accumulation chamber.

7. The combination recessed light and smoke detector and carbon monoxide sensor of claim 6, and further comprising;
a step formed between a horizontal flange of the wafer light and the smoke hole.

8. The combination recessed light and smoke detector and carbon monoxide sensor of claim 1, and further comprising:
the recessed light is a wafer recessed light with an LED light source;
the recessed light having a horizontal flange to mount the recessed light to an opening in a ceiling surface;
a cover plate forming a smoke collection chamber;
the cover plate is located above the horizontal flange and on an outer side of the wafer light; and,
a smoke hole connecting the smoke collection chamber to a space below the wafer light.

9. The combination recessed light and smoke detector and carbon monoxide sensor of claim 8, and further comprising:
the cover plate extends around the wafer light less than 360 degrees.

10. An assembly of recessed lights mounted to a ceiling of a room comprising;
each recessed light having an LED light source of around 20 volts;
one of the recessed lights having a smoke detection sensor associated with that recessed light;
a power conversion device having a 110-volt input and a 20-volt output; and,
each of the LED light sources of the recessed lights connected to the 20-volt output of the power conversion device to power the LED light sources.

11. The assembly of recessed lights mounted to a ceiling of a room of claim 10, and further comprising:
the recessed lights are wafer recessed lights.

12. The assembly of recessed lights mounted to a ceiling of a room of claim 10, and further comprising:
a box mounted to a wall of the room;
the box having a battery, a speaker, a test button, and a carbon monoxide sensor;
the smoke detection sensor connected to the box; and,
the box is powered by a wire from the 20-volt output;
wherein the speaker sounds an alarm when the smoke detection sensor detects smoke in the room or the carbon monoxide sensor detects carbon monoxide in the room.
